(19) United States
(12) Patent Application Publication
(10) Pub. No.: US 2023/0379991 A1
(43) Pub. Date: Nov. 23, 2023

(54) IN-VEHICLE TERMINAL, INFORMATION PROCESSING METHOD AND VEHICLE

(71) Applicant: TOYOTA JIDOSHA KABUSHIKI KAISHA, Aichi-ken (JP)

(72) Inventor: Keizoh KAWAGUCHI, Okazaki-shi (JP)

(21) Appl. No.: 18/320,999

(22) Filed: May 22, 2023

(30) Foreign Application Priority Data
May 23, 2022 (JP) 2022-083765

(51) Int. Cl. H04W 76/14

(52) U.S. Cl. CPC H04W 76/14; B60R 25/24

(57) ABSTRACT

An in-vehicle terminal performs a processing related to a remote service of a vehicle. When a first event occurs, a controller of the in-vehicle terminal determines whether short-range wireless communication between the vehicle and a user terminal is being established. In a case where it is determined that short-range wireless communication between the vehicle and a user terminal is not being established, the controller executes a first process. On other hands, in a case where it is determined that short-range wireless communication between the vehicle and the user terminal is being established, the controller executes a second process different from the first process.

### CROSS REFERENCE TO THE RELATED APPLICATION

This application claims the benefit of Japanese Patent Application No. 2022-83765, filed on May 23, 2022, which is hereby incorporated by reference herein in its entirety.

### BACKGROUND

### Technical Field

The present disclosure relates to an in-vehicle terminal, an information processing method and a vehicle.

### Description of the Related Art

A technique is known for preventing remote operation of a vehicle when a user is located outside vehicle in the vicinity of the vehicle or inside the vehicle (see, for example, Patent Literature 1).

### CITATION LIST

### Patent Literature

Patent Literature 1: Japanese Patent Application Laid-Open No. 2006-315462

### SUMMARY

An object of the present disclosure is to provide a technology capable of improving convenience for vehicle users.

In an aspect of the present disclosure, there is provided an in-vehicle terminal that performs a processing related to a remote service of a vehicle. The in-vehicle terminal may be, for example, comprising a controller including at least one processor. The controller may be configured to execute processing of: executing a first process in a case where short-range wireless communication between the vehicle and a user terminal is not being established at the time a first event occurs; and executing a second process different from the first process in a case where short-range wireless communication between the vehicle and the user terminal is being established at the time the first event occurs.

In another aspect of the present disclosure, there is provided an information processing method related to remote service of a vehicle. The information processing method may be comprise, for example, the following steps of processing executed by a computer: determining whether short-range wireless communication between the vehicle and an user terminal is being established at the time a first event occurs; executing a first process in a case where it is determined that short-range wireless communication between the vehicle and the user terminal is not being established; and executing a second process different from the first process in a case where it is determined that short-range wireless communication between the vehicle and the user terminal is being established.

The present disclosure also relates to a program for causing a computer to execute the above-described information processing method, or a non-transitory storage medium for storing the program.

In other aspects of the present disclosure, there are also provided a vehicle. The vehicle may be equipped with a first communication apparatus configured to perform short-range wireless communication with a user terminal and an in-vehicle terminal configured to perform processing related to a remote service of a vehicle. The in-vehicle terminal may comprise a controller including at least one processor. The controller may be, for example, configured to execute processing of: determining whether short-range wireless communication between the vehicle and the user terminal is being established at the time a first event occurs; executing a first process in a case where it is determined that short-range wireless communication between the vehicle and the user terminal is not being established; and executing a second process different from the first process in a case where it is determined that short-range wireless communication between the vehicle and the user terminal is being established.

The present disclosure can provide a technology capable of improving convenience for vehicle users.

### BRIEF DESCRIPTION OF THE DRAWINGS

FIG. 1 is a diagram illustrating an overview of a remote system.

FIG. 2 is a diagram illustrating an example of an ECUs mounted on a vehicle.

FIG. 3 is a diagram illustrating an example of a sensors mounted on a vehicle.

FIG. 4 is a diagram illustrating an example of hardware configuration of each of the in-vehicle terminal, the user terminal, and the server apparatus included in the remote system.

FIG. 5 is a block diagram illustrating an example of the functional configuration of the in-vehicle terminal according to the first embodiment.

FIG. 6 is a diagram illustrating an example of a sequence of processes executed by each component included in the remote system and the ECU of the vehicle according to the first embodiment.

FIG. 7 is an example of a flowchart of a processing routine executed by the in-vehicle terminal according to the first embodiment, which is triggered by the reception of the first signal.

FIG. 8 is an example of a flowchart of a processing routine executed by the in-vehicle terminal according to the second embodiment, which is triggered by the switching of the ignition switch from on to off.

### DESCRIPTION OF THE EMBODIMENTS

In recent years, technologies that provide users with remote services for vehicles through application programs installed on user terminals such as smartphones have become popular. In the remote service, the user can operate the vehicle at a distance from the vehicle or check a status of the vehicle at distance from the car, for example, through an application program of the user terminal. Incidentally, when an event related to the remote service occurs, if the same processing is performed on the vehicle side in a case where the user is in the vicinity of the vehicle and in a case where the user is at a place away from the vehicle, there is a possibility that the convenience of the user is impaired.

In contrast, the in-vehicle terminal according to the present disclosure is mounted on a vehicle and executes a process related to the remote service. Specifically, when the short-range wireless communication between the vehicle and the user terminal is not established at the time of the occurrence of the first event, the controller of the in-vehicle terminal executes the first process. On other hands, when the short-range wireless communication between the vehicle and the user terminal is established at the time of the occurrence of the first event, the controller of the in-vehicle terminal executes a second process different from the first process.

The “first event” referred to herein is an event that triggers when the controller of the in-vehicle terminal executes the process related to the remote service. The first event is, for example, that the in-vehicle terminal receives a signal requesting remote operation of the vehicle, or that the ignition switch of the vehicle is switched from on to off, and the like.

The “short-range wireless communication” referred to herein is a wireless communication established when the user terminal is located within a range of several meters (for example, about 1 meter to 3 meters) from the vehicle, and not established when the user terminal is located outside the range. In other words, the “short-range wireless communication” is a wireless communication established when a user carrying a user terminal is located within a range within which a user carrying a user terminal can visually see a vehicle, and not established when a user carrying a user terminal is located outside the range. As such short-range wireless communication, for example, wireless communication of the Bluetooth® Low Energy standard (hereinafter sometimes referred to as “BLE”) can be used.

According to the in-vehicle terminal according to the present disclosure, when the first event related to the remote service occurs, different processes are performed depending on whether short-range wireless communication between the vehicle and the user terminal is established or not. executed. In other words, the process executed by the in-vehicle terminal when the first event occurs can be made different depending on whether the user is positioned within the range where the user can see the vehicle or when the user is positioned outside the range. This makes it possible to enhance the convenience of the user.

The first event in the present disclosure may be that the in-vehicle terminal receives a signal requesting remote operation of the vehicle. In that case, the controller of the in-vehicle terminal according to the present disclosure may execute, as a first process, a process for determining whether the first condition is satisfied and a process for accepting a remote operation when it is determined that the first condition is satisfied. Further, the controller of the in-vehicle terminal according to the present disclosure may execute, as the second process, a process for accepting a remote operation without determining whether the first condition is satisfied.

The “first condition” referred to herein is a condition for operating the target device of remote operation without any trouble. Such a first condition is, for example, (1) a first sensor which detects a smart key present in the interior of the vehicle does not detect the smart key, (2) a second sensor which detects that the bonnet hood of the vehicle is open does not detect that the bonnet hood is open, or (3) a third sensor which detects a moving object (for example, a person, etc.) intruding into the interior of the vehicle does not detect the moving object.

The condition (1) above is a condition for confirming that the smart key is not left in the vehicle when, for example, the corresponding remote operation involves locking the door. The condition (2) above is, for example, a condition for confirming that the user or the like is not working by opening the hood when the corresponding remote operation involves starting the engine. The condition (3) above is, for example, a condition for confirming that a moving object that may be pinched by the window has not intruded into the interior of the vehicle when the corresponding remote operation is a window closing operation. The first condition is not limited to the conditions (1) to (3) described above, and any condition may be used as long as it is a condition for operating the target device of remote operation without any problem.

The “process of accepting the remote operation” here may include, for example, a process in which the controller transmits a signal requesting an operation corresponding to the remote operation to the first ECU (Electronic Control Unit) mounted on the vehicle. The first ECU is an ECU for controlling an in-vehicle device that performs an operation corresponding to remote operation.

If the short-range wireless communication between the vehicle and the user terminal is established, it can be estimated that the user is located within a visual range of the vehicle. In such a case, the user can visually confirm whether the first condition as described above is satisfied. Accordingly, when short-range wireless communication between the vehicle and the user terminal is established, it is less necessary for the vehicle side to determine whether the first condition is satisfied. Therefore, in the in-vehicle terminal according to the present disclosure, when the short-range wireless communication between the vehicle and the user terminal is established, the controller accepts the remote operation without determining whether the first condition is satisfied (the second process is performed). Thus, when the user is located within a range where the vehicle can be visually viewed, the response delay of the remote operation can be shortened compared with the case where the user is located outside the range where the vehicle can be visually viewed. As a result, the convenience of the user can be enhanced.

The first event in the present disclosure may be that the ignition switch is switched from on to off. In that case, the controller of the in-vehicle terminal according to the present disclosure may execute, as a first process, a process of determining whether the state of the vehicle is in a first state, and a process of transmitting a signal indicating the first state to the user terminal through a server apparatus outside the vehicle (hereinafter, “inadvertent notification process” may be described) in a case where it is determined that the state of the vehicle is in the first state. Further, the controller of the in-vehicle terminal according to the present disclosure may execute, as a second process, a process of transmitting a signal indicating the state of the vehicle to the user terminal in real time through the server apparatus.

The “first state” referred to here is, for example, a state of a vehicle that is not suitable for parking. Such a first state is, for example, (4) a state in which the doors of the vehicle are not locked, (5) a state in which the lighting device of the vehicle is not turned off, (6) a state in which the windows of the vehicle are not closed, or (7) a state in which the hazard lamps of the vehicle are not turned off.

By the way, after the ignition switch of the vehicle is switched from on to off, a situation in which the user takes a break in the vehicle or outside the vehicle in the vicinity of the vehicle may occur. Further, after the ignition switch of the vehicle is switched from on to off, a situation in which the user performs work such as car washing or inspection may occur. In these situations, it is highly possible that the state in which the doors are not locked, the lighting device is not turned off, the windows are not closed, the hazard lamps are not turned off, or the like is intentionally caused by the user. In such a case, if the inadvertent notification process is executed, the user may feel troublesome.

In contrast, in the in-vehicle terminal according to the present disclosure, if the short-range wireless communication between the vehicle and the user terminal is established when the ignition switch is switched from on to off, the controller performs the process of transmitting a signal indicating the state of the vehicle to the user terminal in real time, without performing the inadvertent notification process. This can suppress the user from feeling troublesome. As a result, the convenience of the user can be enhanced.

The in-vehicle terminal according to the present disclosure may further provide a memory for storing information that identifies a user terminal. In that case, the controller may execute the processing of: acquiring identification information of a first device for which a short-range wireless communication has been established with the vehicle; determining whether the first device is the user terminal based on the information stored in the memory and an identification information of the first device; determining that the short-range wireless communication between the vehicle and the user terminal has been established when the first device is determined to be the user terminal; and determining that the short-range wireless communication between the vehicle and the user terminal has not been established when the first device is determined to be not the user terminal. Thus, it is possible to determine whether the short-range wireless communication between the vehicle and the user terminal has been established.

Another aspect of the present disclosure is a vehicle including a first communication device that performs short-range wireless communication with a user terminal, and an in-vehicle terminal that performs processing related to a remote service of the vehicle. In that case, a controller of the in-vehicle terminal determines whether the short-range wireless communication between the first communication device and the user terminal is established when a first event occurs. When it is determined that the short-range wireless communication between the first communication device and the user terminal has not been established, the controller of the in-vehicle terminal executes a first process. On other hands, when it is determined that the short-range wireless communication between the first communication device and the user terminal has been established, the controller of the in-vehicle terminal executes a second process different from the first process. This makes it possible to enhance the convenience of the user.

Hereinafter, specific embodiments of the present disclosure will be described with reference to the drawings. The following configurations of the embodiments are exemplary, and the present disclosure is not limited to the configurations of the embodiments.

### First Embodiment

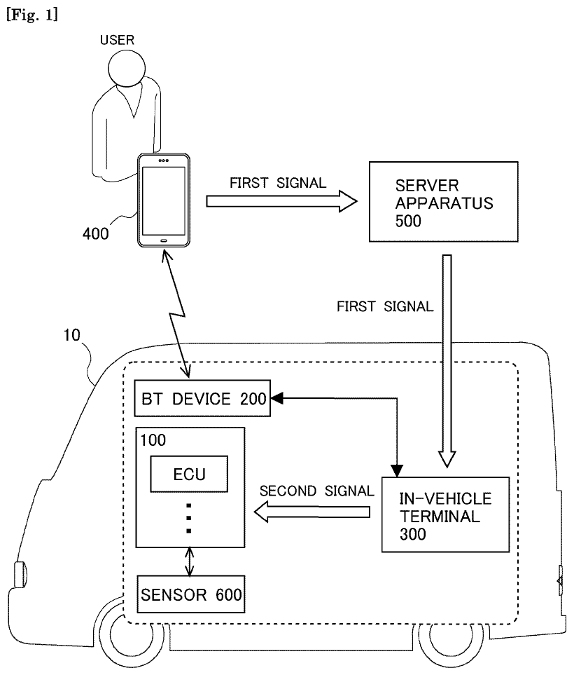

A first embodiment of the present disclosure will be described with reference to FIGS. 1 to 6. In the present embodiment, an example in which the in-vehicle terminal according to the present disclosure is applied to a remote system will be described. The remote system is a system that provides a remote service of the vehicle to a user of the vehicle.

(Outline of System)

FIG. 1 is a diagram illustrating an outline of a remote system to which the information processing apparatus according to the present disclosure is applied. The remote system in the present embodiment includes an in-vehicle terminal 300 mounted on the vehicle 10, a user terminal 400 used by the first user, and a server apparatus 500 installed outside the vehicle 10. In the example indicated in FIG. 1, only one vehicle 10 and one user terminal 400 are illustrated, but under the management of the server apparatus 500, a plurality of vehicles 10 and a plurality of user terminals 400 corresponding to each of the plurality of vehicles 10 may be included.

The vehicle 10 in the present embodiment is a PHEV (Plug-in Hybrid Electric Vehicle) or a BEV (Battery Electric Vehicle) including a battery that can be charged by an external power supply. In addition to the in-vehicle terminal 300, the vehicle 10 is equipped with an ECU 100, a sensor 600, and a BT device 200.

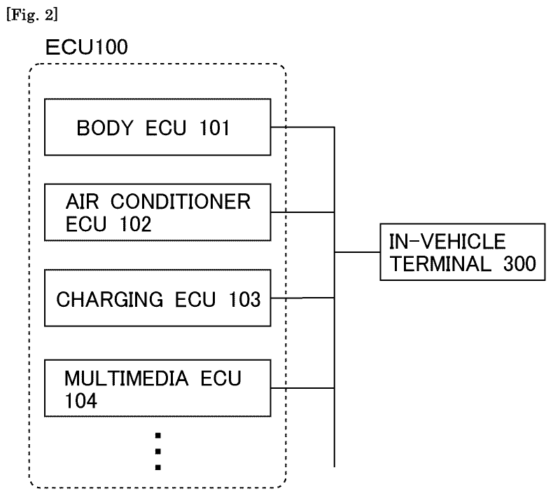

The ECU 100 is a computer for controlling various devices mounted on the vehicle 10. As illustrated in FIG. 2, for example, the ECU 100 includes a plurality of ECUs such as a body ECU 101, an air conditioner ECU 102, a charging ECU 103, and a multimedia ECU 104. The body ECU 101, the air conditioner ECU 102, the charging ECU 103, and the multimedia ECU 104 are connected to each other via an in-vehicle network. As an example, the in-vehicle network may be a network based on a standard such as CAN (Controller Area Network), LIN (Local Interconnect Network), or Flex Ray.

The body ECU 101 controls a door lock actuator, a power window actuator, a hazard lamp, a lighting device (for example, a headlight, a small light, a blinker lamp, etc.), and the like. The air conditioner ECU 102 controls the air conditioner. The charging ECU 103 controls charging of the battery by an external power supply. The multimedia ECU 104 controls a multimedia device such as a navigation system or display audio. The body ECU 101, the air conditioner ECU 102, the charging ECU 103, and the multimedia ECU 104 are examples of the “first ECU” according to the present disclosure.

In the example indicate FIG. 2, a part of the ECU related to the remote operation described later is extracted and illustrated. However, the ECU 100 may also include an ECU for controlling a prime mover, an ECU for controlling a braking device, and an ECU for controlling an advanced safety system. The vehicle 10 to which the present disclosure is applicable is not limited to PHEV and BEV, and may be an internal combustion engine vehicle, a HEV (Hybrid Electric Vehicle), a BEV equipped with an internal combustion engine for power generation, or a FCEV (Fuel Cell Electric Vehicle. Accordingly, the types of ECUs included in the ECU 100 may also differ from the examples indicate FIG. 2.

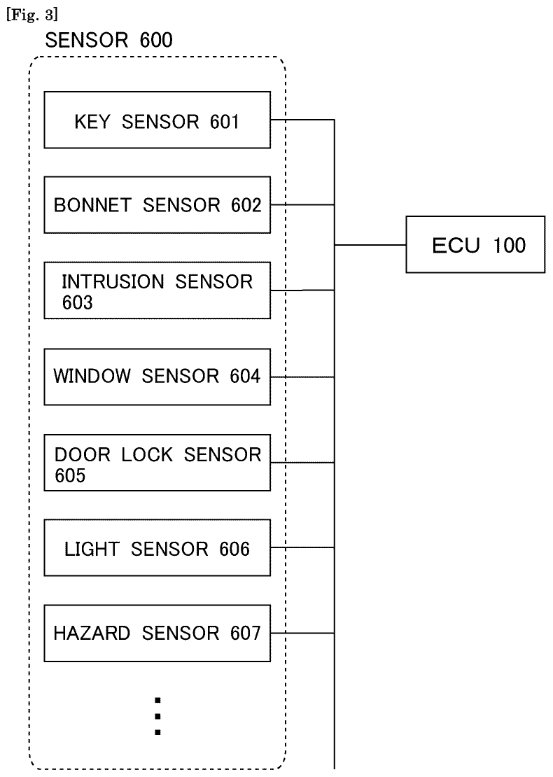

The sensor 600 detects the state of various devices mounted on the vehicle 10. The sensor 600 includes, for example, a key sensor 601, a bonnet sensor 602, an intrusion sensor 603, a window sensor 604, a door lock sensor 605, a light sensor 606, a hazard sensor 607, and the like, as indicate FIG. 3. The key sensor 601, the bonnet sensor 602, the intrusion sensor 603, the window sensor 604, the door lock sensor 605, the light sensor 606, and the hazard sensor 607 are connected to the ECU 100 through the in-vehicle network.

The key sensor 601 detects a smart key (electronic key) present in the interior of the vehicle 10 by using radio waves in the low frequency (hereinafter referred to as “LF”) band. The bonnet sensor 602 detects opening and closing of the bonnet hood of the vehicle 10. The intrusion sensor 603 detects a moving object (person, etc.) that is invading the interior of the vehicle 10. The window sensor 604 detects the opening and closing position of the window of the vehicle 10. The door lock sensor 605 detects the position (lock position and unlock position) of the lock mechanism of the door of the vehicle 10. The light sensor 606 detects the position of the light switch of the vehicle 10 (the position where the headlight and the small light are turned on, the position where only the small light is turned on, the position where the headlight and the small light are turned off). The hazard sensor 607 detects the position of the hazard switch of the vehicle 10 (the position where the hazard light is turned on and the position where the hazard light is turned off).

In the example indicate FIG. 3, a part of the sensor related to the remote operation described later is extracted and illustrated, but a sensor related to the control of the prime mover, a sensor related to the control of the braking device, and a sensor related to the control of the advanced safety system may also be mounted on the vehicle 10.

The BT device 200 performs short-range wireless communication (hereinafter referred to as “BT communication”) of the BLE standard with a device located within a predetermined distance (for example, within a range of 1 meter to 3 meters) from the vehicle 10 (including the interior of the vehicle 10). The BT device 200 may be an interface for BLE that is mounted on an in-vehicle multimedia device (e.g., a navigation system, display audio, etc.). The BT device 200 is connected to the ECU 100 through the in-vehicle network.

The in-vehicle terminal 300 is mounted on the vehicle 10 and connected to the server apparatus 500 through a network outside the vehicle (network Ni described later). The in-vehicle terminal 300 is connected to the ECU 100 through the in-vehicle network described above. When the in-vehicle terminal 300 receives a first signal (a signal requesting a remote operation of the vehicle 10) transmitted from the server apparatus 500, the in-vehicle terminal 300 transmits a second signal (a signal requesting a work corresponding to the remote operation) to the ECU 100 through the in-vehicle network. At that time, the in-vehicle terminal 300 specifies the ECU 100 that controls the device to be operated remotely (the device that realizes the operation corresponding to the remote operation), and transmits the second signal to the specified ECU 100.

In addition to the above functions, the in-vehicle terminal 300 in the present embodiment has a function of switching the process executed when the first signal is received according to whether or not the BT communication between the user terminal 400 and the BT device 200 is established. Specifically, when the first signal is received, the in-vehicle terminal 300 determines whether the BT communication between the user terminal 400 and the BT device 200 is established. When it is determined that the BT communication between the user terminal 400 and the BT device 200 has not been established, the in-vehicle terminal 300 determines whether the reception condition (first condition) for remote operation is satisfied. When it is determined that the first condition is satisfied, the in-vehicle terminal 300 accepts the remote operation (transmits the second signal to the ECU 100). On the other hand, when it is determined that the first condition is not satisfied, the in-vehicle terminal 300 does not accept the remote operation (the second signal is not transmitted to the ECU 100). In addition, when it is determined that the BT communication between the user terminal 400 and the BT device 200 has been established, the in-vehicle terminal 300 accepts the remote operation without determining whether or not the first condition is satisfied.

The user terminal 400 is a portable computer used by a user (first user) who has ownership or use rights of the vehicle 10. The user terminal 400 has a function of presenting a menu of remote operations to the first user, a function of accepting a remote operation selected by the first user, a function of transmitting a signal (first signal) requesting a remote operation selected by the first user to the server apparatus 500, and like. The remote operation menu includes, for example, a lock operation of the door of the vehicle 10, an unlocking operation of the door of the vehicle 10, an opening operation of the window of the vehicle 10, a closing operation of the window of the vehicle 10, an operation of operating the air conditioner, an operation of stopping the operation of the air conditioner, an operation of turning off the headlight/small light, an operation of turning on the hazard lamp, an operation of turning off the hazard lamp, an operation of sounding a car horn, an operation of starting charging the battery, a battery charging stop operation, and like. The first signal also includes information (operation ID) that identify remote operation selected by the first user and information (terminal ID) that identifies the user terminal 400.

The server apparatus 500 is a computer installed outside the vehicle 10 and providing remote services to a first user of the vehicle 10. The server apparatus 500, when receiving the first signal transmitted from the user terminal 400, specifies the vehicle 10 associated with the user terminal 400, and transmits the first signal to the in-vehicle terminal 300 of the specified vehicle 10. The specification of the vehicle 10 associated with the user terminal 400 is performed based on the terminal ID included in the first signal.

(Hardware Configuration of Remote System)

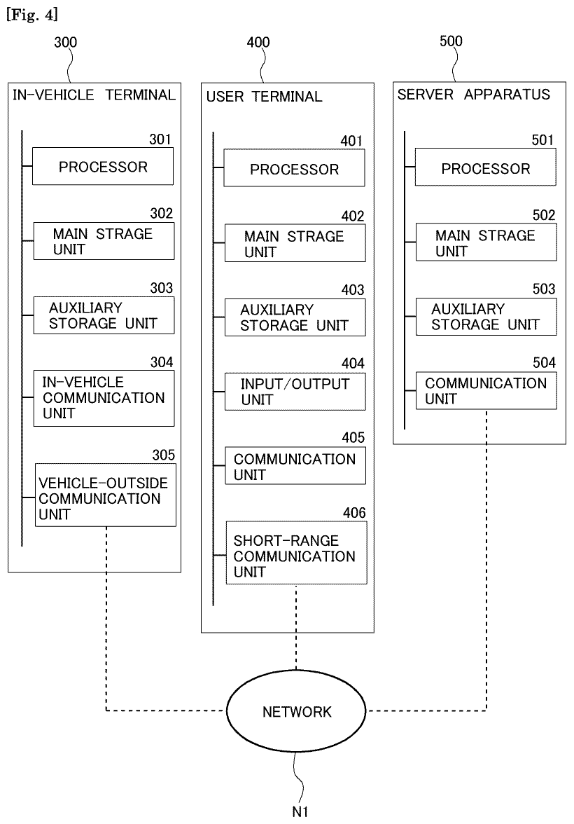

Here, an example of each hardware configuration of the in-vehicle terminal 300, the user terminal 400, and the server apparatus 500 included in the remote system will be described. FIG. 4 is a diagram illustrating an example of a hardware configuration of each of the in-vehicle terminal 300, the user terminal 400, and the server apparatus 500 included in the remote system.

The in-vehicle terminal 300 is a computer mounted on the vehicle 10. As indicate FIG. 4, the in-vehicle terminal 300 in the present embodiment includes a processor 301, a main storage unit 302, an auxiliary storage unit 303, an in-vehicle communication unit 304, a vehicle-outside communication unit 305, and the like. In FIG. 4, only the hardware components that perform processing related to the remote operation are extracted from the hardware components of the in-vehicle terminal 300, and hardware components other than the hardware components shown in FIG. 4 (for example, a hardware component for providing a multimedia service to an occupant of the vehicle 10, a hardware component for performing processing related to an emergency call, and the like) may be included in the in-vehicle terminal 300.

The processor 301 is, for example, a central processing unit (CPU) or a digital signal processor (DSP). The processor 301 controls the in-vehicle terminal 300 by performing various arithmetic processing.

The main storage unit 302 includes, for example, a semiconductor memory such as a random access memory (RAM) and a read-only memory (ROM). The main storage unit 302 provides a storage area for loading a program stored in the auxiliary storage unit 303 and a work area for executing the program. The main storage unit 302 is used as a buffer for arithmetic processing by the processor 301.

The auxiliary storage unit 303 is, for example, an EPROM (Erasable Programmable ROM) or a hard disk drive (HDD). The auxiliary storage unit 303 may include removable media, that is, portable recording media. The removable media is, for example, a disk recording medium such as a USB (Universal Serial Bus) memory, a CD (Compact Disc), a DVD (Digital Versatile Disc), and the like. The auxiliary storage unit 303 stores various programs, data used by the processor 301 when executing each program, and the like.

The program stored in the auxiliary storage unit 303 includes an operating system (OS), an application program for causing the processor 301 to execute the process related to the remote service (hereinafter, referred to as the “first application program”), and like. The data stored in the auxiliary storage unit 303 includes the terminal ID of the user terminal 400.

Note that some or all of the information stored in the auxiliary storage unit 303 may be stored in the main storage unit 302. Further, a part of the information stored in the main storage unit 302 may be stored in the auxiliary storage unit 303.

The in-vehicle communication unit 304 is a communication interface for connecting the in-vehicle terminal 300 to the in-vehicle network. In the present embodiment, the in-vehicle communication unit 304 communicates with the ECU 100 through the in-vehicle network.

The vehicle-outside communication unit 305 is a communication interface for connecting the in-vehicle terminal 300 to the network Ni outside the vehicle. The vehicle-outside communication unit 305 connects to the network Ni by, for example, a mobile communication method (LTE (Long Term Evolution), LTE-Advanced, 5G (5th Generation), 6G (6th Generation), etc.), or a wireless communication method such as Wi-Fi (registered trademark). In the present embodiment, the vehicle-outside communication unit 305 communicates with the server apparatus 500 through the network Ni.

In the in-vehicle terminal 300 configured as described above, when the vehicle-outside communication unit 305 receives the first signal transmitted from the server apparatus 500, the processor 301 loads the first application program stored in the auxiliary storage unit 303 to the main storage unit 302 and executes it. The processor 301 executes processing related to the remote operation through execution of the first application program. The processing related to the remote operation executed by the processor 301 will be described later.

A series of processes executed by the in-vehicle terminal 300 can be executed by hardware, but can also be executed by software. The hardware configuration of the in-vehicle terminal 300 is not limited to the example indicate FIG. 4, and the components may be omitted, replaced, or added as appropriate.

The user terminal 400 is a computer used by the first user. The user terminal 400 is, for example, a smartphone, a mobile phone, a tablet terminal, a wearable computer (smartwatch, etc.), or a personal computer. As indicate FIG. 4, the user terminal 400 in the present embodiment includes a processor 401, a main storage unit 402, an auxiliary storage unit 403, an input/output unit 404, a communication unit 405, a short-range communication unit 406, and the like. In the example illustrated in FIG. 4, only the hardware component that performs the process related to the remote operation is illustrated among the hardware components of the user terminal 400. However, hardware components other than the hardware components illustrated in FIG. 4 (for example, a hardware component for acquiring the current position of the user terminal 400, a hardware component for outputting sound, and the like) may be included in the user terminal 400.

The processor 401, the main storage unit 402, and the auxiliary storage unit 403 of the user terminal 400 are the same as the processor 301, the main storage unit 302, and the auxiliary storage unit 303 of the in-vehicle terminal 300, respectively. However, the program stored in the auxiliary storage unit 403 of the user terminal 400 includes an OS and an application program for causing the processor 401 to execute the process related to the remote service (hereinafter, referred to as the “second application program”).

The input/output unit 404 accepts an input operation performed by the first user. The input/output unit 404 also presents information to the first user. The input/output unit 404 includes, for example, a touch panel display and a control circuit thereof. In the present embodiment, the input/output unit 404 displays the menu screens of the plurality of application programs (including the second application programs) installed in the user terminal 400 on the touch panel display, and accepts the selection operation of the application program by the first user. When the second application program is selected by the first user, the input/output unit 404 displays a menu screen for remote operation on the touch panel display, and accepts a selection operation for remote operation by the first user.

The communication unit 405 is a communication interface for connecting the user terminal 400 to the network Ni by wire or wireless. In the present embodiment, the communication unit 405 communicates with the server apparatus 500 through the network Ni. The communication unit 405 is, for example, a NIC (Network Interface Card), an optical communication circuit, a wireless communication circuit, or the like.

The short-range communication unit 406 is a communication interface that performs BT communication with the in-vehicle terminal 300. The short-range communication unit 406 in the present embodiment communicates with the BT device 200 of the in-vehicle terminal 300 using the wireless communication of the BLE standard.

In the user terminal 400 configured as described above, when the first user performs an operation to select the second application program on the menu screen of the application program displayed on the touch panel display of the input/output unit 404, the processor 401 loads the second application program stored in the auxiliary storage unit 403 into the main storage unit 402 and executes it. When the execution of the second application program is started, the processor 401 causes the touch panel display of the input/output unit 404 to display a screen including a button for calling up the menu screen for remote operation. When a button for calling up a menu screen for remote operation is operated by the first user on this screen, the processor 401 causes the menu screen for remote operation to be displayed on the touch panel display of the input/output unit 404.

When the first user performs an operation to select the desired remote operation while the menu screen for remote operation is displayed on the touch panel display of the input/output unit 404, the processor 401 transmits the first signal including the operation ID and the terminal ID of the selected remote operation to the server apparatus 500 through the communication unit 405.

A series of processes executed by the user terminal 400 can be executed by hardware, but can also be executed by software. The hardware configuration of the user terminal 400 is not limited to the example indicate FIG. 4, and the components may be omitted, replaced, or added as appropriate.

Next, the server apparatus 500 will be described. The server apparatus 500 is a computer located outside the vehicle 10. The server apparatus 500 of the present embodiment is administered by, for example, a manufacturer of the vehicle 10, a company commissioned by the manufacturer of the vehicle 10, or the like. As indicate FIG. 4, the server apparatus 500 includes a processor 501, a main storage unit 502, an auxiliary storage unit 503, a communication unit 504, and the like.

In the example illustrated in FIG. 4, only the hardware components that perform the process related to the remote operation among the hardware components of the server apparatus 500 are illustrated, but the hardware components other than the hardware components illustrated in FIG. 4 (for example, hardware components for providing services other than the remote operation) may be included in the server apparatus 500.

The processor 501, the main storage unit 502, the auxiliary storage unit 503, and the communication unit 504 of the server apparatus 500 are the same as the processor 401, the main storage unit 402, the auxiliary storage unit 403, and the communication unit 405 of the user terminal 400, respectively. However, the program stored in the auxiliary storage unit 503 of the server apparatus 500 includes a program for causing the processor 501 to execute the process related to the remote service in addition to the OS. The data stored in the auxiliary storage unit 503 of the server apparatus 500 includes data that associates the user terminal 400 with the vehicle 10. The data associated with the user terminal 400 and the vehicle 10 is, for example, data associated with the terminal ID of the user terminal 400 and the identification information (vehicle ID) of the vehicle 10.

The server apparatus 500 configured as described above specifies the vehicle 10 associated with the user terminal 400 based on the terminal ID included in the first signal and the data stored in the auxiliary storage unit 503 when the communication unit 504 receives the first signal transmitted from the user terminal 400. The server apparatus 500 transmits the first signal to the specified vehicle 10 in-vehicle terminal 300 through the communication unit 504.

A series of processes executed by the server apparatus 500 can be executed by hardware, but can also be executed by software. The hardware configuration of the server apparatus 500 is not limited to the example illustrated in FIG. 4, and the components may be omitted, replaced, or added as appropriate.

(Functional Configuration of In-Vehicle Terminals)

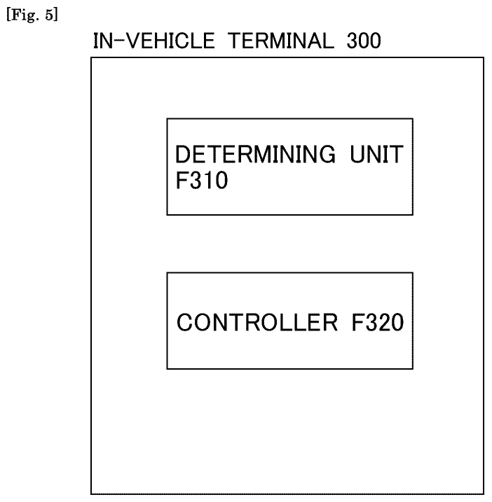

Here, an example of a functional configuration of the in-vehicle terminal 300 in the present embodiment will be described. FIG. 5 is a block diagram illustrating an example of the functional configuration of the in-vehicle terminal 300. The in-vehicle terminal 300 in the present embodiment includes a determining unit F310 and a controller F320 as functional components thereof. The determining unit F310 and the controller F320 are achieved by the processor 301 of the in-vehicle terminal 300 loads the first application program stored in the auxiliary storage unit 303 into the main storage unit 302 and executes it. The processor 301 that achieves the determining unit F310 and the controller F320 corresponds to the “controller” of the “in-vehicle terminal” according to the present disclosure.

The determining unit F310 determines whether BT communication between the user terminal 400 and the BT device 200 has been established, triggered by the vehicle-outside communication unit 305 receiving the first signal transmitted from the server apparatus 500. Specifically, the determining unit F310 acquires identification information (ID) of the device (first device) for which BT communication is established with the BT device 200 by communicating with the multimedia ECU 104 through the in-vehicle communication unit 304. The determining unit F310 collates the ID of the first device with the terminal ID stored in the auxiliary storage unit 303 (terminal ID of the user terminal 400 used by the first user). When the ID of the first device and the terminal ID of the user terminal 400 match, the determining unit F310 determines that the BT communication between the user terminal 400 and the BT device 200 is established. On the other hand, when the ID of the first device and the terminal ID of the user terminal 400 do not match, the determining unit F310 determines that the BT communication between the user terminal 400 and the BT device 200 has not been established. When there is no device in which BT communication is established with the BT device 200, the determining unit F310 determines that BT communication between the user terminal 400 and the BT device 200 has not been established. The determination result by the determining unit F310 is passed to the controller F320 together with the first signal.

The controller F320 executes different processes according to the determination result by the determining unit F310. In the present embodiment, when the determining unit F310 determines that the BT communication between the user terminal 400 and the BT device 200 has not been established, the controller F320 determines whether the first condition is satisfied. The first condition is a condition for working the target device subject to remote operation without any trouble. The first condition includes, for example, (1) no smart key is present in the interior of the vehicle 10, (2) the bonnet hood of the vehicle 10 is closed, or (3) no moving object (for example, a person, etc.) has entered the interior of the vehicle 10.

The condition (1) above is a condition for confirming that the smart key of the vehicle 10 is not left in the vehicle. The condition (1) above can be used as a first condition when the remote operation is a locking operation of the door of the vehicle 10. Whether or not the condition (1) above is satisfied is determined based on the detection signal of the key sensor 601. The detection signal of the key sensor 601 is acquired by the processor 301 of the in-vehicle terminal 300 communicating with the body ECU 101 through the in-vehicle communication unit 304.

The condition (2) above is a condition for confirming that the user or the like is not working by opening the bonnet hood. The condition (2) above can be used as a first condition when the remote operation is an operation of the air conditioner with the engine start. Whether or not the condition (2) above is satisfied is determined based on the detection signal of the bonnet sensor 602. The detection signal of the bonnet sensor 602 is acquired by the processor 301 of the in-vehicle terminal 300 communicating with the body ECU 101 through the in-vehicle communication unit 304.

The condition (3) above is a condition for confirming that the moving object that may be sandwiched between the windows has not entered the interior of the vehicle 10. The condition (3) above can be used as a first condition when the remote operation is a window closing operation of the vehicle 10. Whether or not the condition (3) above is satisfied is determined based on the detection signal of the intrusion sensor 603. The detection signal of the intrusion sensor 603 is acquired by the processor 301 of the in-vehicle terminal 300 communicating with the body ECU 101 through the in-vehicle communication unit 304.

When it is determined that the first condition as described above is satisfied, the controller F320 accepts the remote operation. Specifically, the controller F320 specifies the ECU 100 that controls the target device of the remote operation based on the operation ID included in the first signal. The controller F320 transmits a second signal to the specified ECU 100 through the in-vehicle communication unit 304. The second signal is a signal that requests a working corresponding to the remote operation.

If it is determined that the first condition as described above is not satisfied, the controller F320 does not accept the remote operation. In this case, the second signal is not transmitted from the controller F320 to the ECU 100.

When the determining unit F310 determines that the BT communication between the user terminal 400 and the BT device 200 is established, the controller F320 accepts the remote operation without determining whether or not the first condition is satisfied. That is, when the determining unit F310 determines that the BT communication between the user terminal 400 and the BT device 200 has been established, the controller F320 immediately transmits a second signal to the ECU 100 that controls the device to be operated remotely. This is because, when the BT communication between the user terminal 400 and the BT device 200 is established, the first user is located in or near the vehicle 10 outside the vehicle 10, and the first user can visually confirm whether or not the first condition as described above is satisfied.

Either the determining unit F310 or the controller F320, or a part thereof, may be achieved by a hardware circuit such as an ASIC (Application Specific Integrated Circuit) or a Field Programmable Gate Array (FPGA). Further, the functional configuration of the server apparatus 500 are not limited to the example illustrated in FIG. 5, and the components may be omitted, replaced, or added as appropriate.

(Processing Flow)

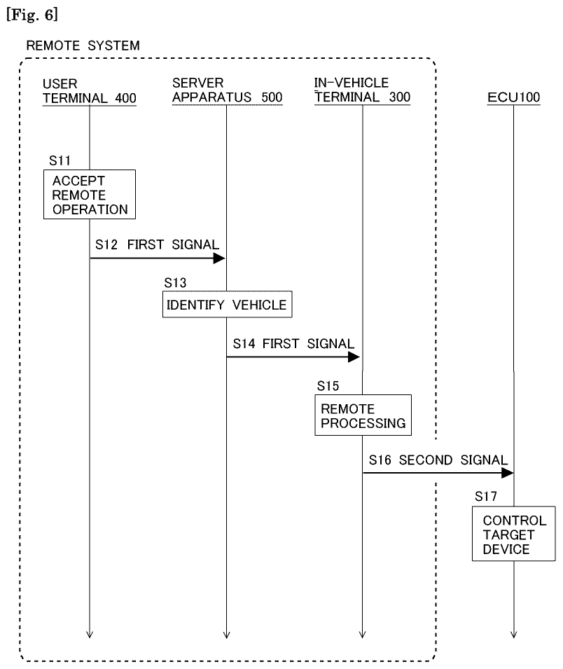

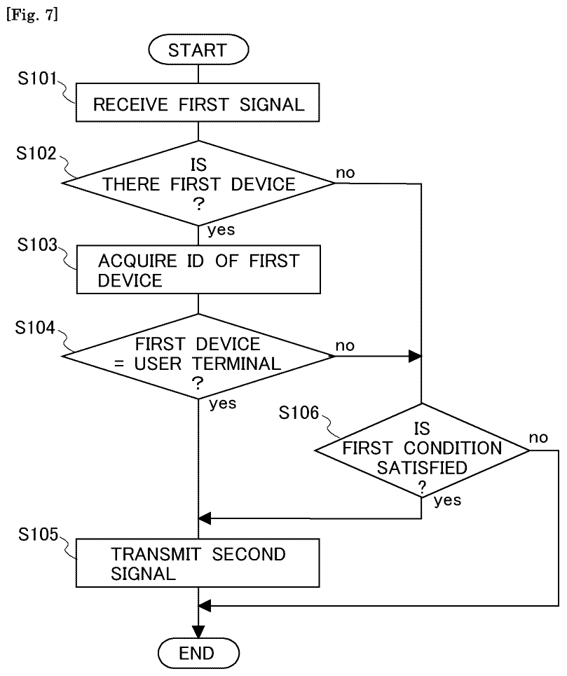

Next, the flow of processing related to the remote operation in the present embodiment will be described with reference to FIGS. 6 and 7. FIG. 6 is a diagram illustrating an example of a sequence of processes executed by each component of the remote system and the ECU 100 of the vehicle 10. FIG. 7 is an example of flow chart of a processing routine executed by the in-vehicle terminal 300 in S15 in FIG. 6.

In FIG. 6, when the user performs an operation to select a desired remote operation in a state where the input/output unit 404 displays a menu screen for remote operation on the touch panel display of the user terminal 400, the processor 401 accepts the remote operation selected by the user (S11).

When the processor 401 of the user terminal 400 accepts the remote operation selected by the user, the processor 401 transmits a first signal including the operation ID of the remote operation selected by the user and the terminal ID of the user terminal 400 to the server apparatus 500 through the communication unit 405 (S12).

When the communication unit 504 of the server apparatus 500 receives the first signal, the processor 501 of the server apparatus 500 identifies the vehicle 10 associated with the user terminal 400 based on the terminal ID included in the first signal and the data stored in the auxiliary storage unit 503 (S13). When the vehicle 10 associated with the user terminal 400 is identified, the processor 501 of the server apparatus 500 transmits the first signal to the in-vehicle terminal 300 of the identified vehicle 10 through the communication unit 504 (S14).

When the in-vehicle terminal 300 of the vehicle 10 associated with the user terminal 400 receives the first signal, the processor 301 executes remote processing (S15). In the remote processing, the processor 301 determines whether the BT communication between the user terminal 400 and the BT device 200 is established. When it is determined that BT communication between the user terminal 400 and the BT device 200 has been established, the processor 301 transmits the second signal to the ECU 100 through the vehicle-outside communication unit 305 (S16). When it is determined that the BT communication between the user terminal 400 and the BT device 200 has not been established, the processor 301 transmits the second signal to the ECU 100 through the vehicle-outside communication unit 305 only when the first condition is satisfied. Details of the remote processing will be described in the explanation of FIG. 7 below.

The ECU 100 that has received the second signal controls the target device of the remote operation according to the second signal (S17).

Next, details of the remote processing (processing of S15 in FIG. 6) executed by the in-vehicle terminal 300 will be described with reference to FIG. 7. The processing routine illustrated in FIG. 7 is executed by triggering the reception of the first signal transmitted from the server apparatus 500 by the in-vehicle terminal 300. It is noted that, the processing routine illustrated in FIG. 7 is executed by the processor 301 of the in-vehicle terminal 300, but in the following description, it will be described as being executed by the functional components of the in-vehicle terminal 300.

In FIG. 7, when the vehicle-outside communication unit 305 of the in-vehicle terminal 300 receives the first signal transmitted from the server apparatus 500 (step S101), the determining unit F310 determines whether there is a device (first device) for which BT communication has been established with the BT device 200 by communicating with the multimedia ECU 104 through the in-vehicle communication unit 304 (step S102). When there is a first device for which BT communication is established with the BT device 200 (positive determination in step S102), the process of step S103 is executed.

In step S103, the determining unit F310 acquires the ID of the first device by communicating with the multimedia ECU 104 through the in-vehicle communication unit 304. The determination unit F310 executes the process of step S104, after finishing execution of the process of step S103.

In step S104, the determining unit F310 determines whether the first device is the user terminal 400 of the first user. In some embodiments, the determining unit F310 collates the ID acquired in step S103 with the terminal ID (terminal ID of the user terminal 400 used by the first user) stored in the auxiliary storage unit 303. When the ID of the first device and the terminal ID of the user terminal 400 match (positive determination in step S104), the BT communication between the user terminal 400 and the BT device 200 is established. In that case, the determining unit F310 passes information indicating that the BT communication between the user terminal 400 and the BT device 200 has been established and a first signal to the controller F320. The controller F320 executes the process of S105 by triggering the receipt of the information from the determining unit F310.

In step S105, the controller F320 accepts the remote operation without determining whether the first condition is satisfied. Specifically, the controller F320 specifies the ECU 100 that controls the target device of the remote operation based on the operation ID included in the first signal. The controller F320 transmits a second signal to the specified ECU 100 through the in-vehicle communication unit 304. The second signal is a signal that requests a working corresponding to the remote operation.

Further, when it is determined in step S102 that there is no first device for which BT communication is established with the BT device 200 (negative determination in step S102), and when it is determined in step S104 that the ID of the first device and the terminal ID of the user terminal 400 do not match (negative determination in step S104), the BT communication between the user terminal 400 and the BT device 200 is not established. In that case, the determining unit F310 passes information indicating that the BT communication between the user terminal 400 and the BT device 200 has not been established, and the first signal to the controller F320. The controller F320 executes the process of step S106 by triggering the reception of the information from the determining unit F310.

In step S106, the controller F320 determines whether the first condition is satisfied. Specifically, first, the controller F320 specifies a target operation of the remote operation based on the operation ID included in the first signal.

When the target operation of the remote operation is a door locking operation, the controller F320 uses the condition (1) described above (that there is no smart key in the interior of the vehicle 10) as the first condition. In that case, the controller F320 acquires the detection signal of the key sensor 601 by communicating with the body ECU 101 through the in-vehicle communication unit 304. The controller F320 determines whether or not a smart key is present in the interior of the vehicle 10 based on the detection signal of the key sensor 601. When the smart key is not present in the interior of the vehicle 10, the controller F320 determines that the first condition is satisfied (positive determination in step S106). On the other hand, when the smart key is present in the interior of the vehicle 10, the controller F320 determines that the first condition is not satisfied (negative determination in step S106).

When the target operation of the remote operation is the operation of the air conditioner, the controller F320 uses the condition (2) described above (the bonnet hood of the vehicle 10 is closed) as the first condition. In that case, the controller F320 acquires the detection signal of the bonnet sensor 602 by communicating with the body ECU 101 through the in-vehicle communication unit 304. The controller F320 determines whether the bonnet hood of the vehicle 10 is closed based on the detection signal of the bonnet sensor 602. When the bonnet hood of the vehicle 10 is closed, the controller F320 determines that the first condition is satisfied (positive determination in step S106). On the other hand, when the bonnet hood of the vehicle 10 is open, the controller F320 determines that the first condition is not satisfied (negative determination in step S106).

When the target operation of the remote operation is the closing operation of the window of the vehicle 10, the controller F320 uses the condition (3) described above (the moving object does not enter the interior of the vehicle 10) as the first condition. In that case, the controller F320 acquires the detection signal of the intrusion sensor 603 by communicating with the body ECU 101 through the in-vehicle communication unit 304. The controller F320 determines whether or not a moving object has entered the interior of the vehicle 10 based on the detection signal of the intrusion sensor 603. When the moving object has not entered the interior of the vehicle 10, the controller F320 determines that the first condition is satisfied (positive determination in step S106). On the other hand, when a moving object enters the interior of the vehicle 10, the controller F320 determines that the first condition is not satisfied (negative determination in step S106).

When it is determined that the first condition described above is satisfied (positive determination in step S106), the controller F320 executes the process in step S105. When it is determined that the first condition described above is not satisfied (negative determination in step S106), the controller F320 ends the execution of the processing routine without accepting the remote operation.

According to the above-described embodiment, if BT communication between the user terminal 400 and the BT device 200 is established when the in-vehicle terminal 300 receives the first signal, the in-vehicle terminal 300 accepts the remote operation without determining whether the first condition is satisfied. That is, if the first user is located in a range where the vehicle 10 can be visually viewed when the in-vehicle terminal 300 receives the first signal, the remote operation is immediately accepted without performing the process of determining whether the first condition is satisfied. Accordingly, it is possible to reduce the response delay time from when the first user performs the remote operation at the user terminal 400 to when the target device of the remote operation actually works.

Furthermore, if the BT communication between the user terminal 400 and the BT device 200 is not established when the in-vehicle terminal 300 receives the first signal, the in-vehicle terminal 300 executes a process of determining whether the first condition is satisfied. Then, the in-vehicle terminal 300 accepts the remote operation only when the first condition is satisfied. That is, if the first user is located outside the range where the vehicle 10 can be visually viewed when the in-vehicle terminal 300 receives the first signal, the remote operation is accepted only when the first condition is satisfied.

As a result, the operation subject to remote operation can be safely performed.

Therefore, according to the present embodiment, when the first user performs the remote operation through the user terminal 400, the in-vehicle terminal 300 may perform different processes depending on whether the first user is in the vicinity of the vehicle 10. As a result, convenience of the first user can be enhanced.

In the present embodiment, the event in which the in-vehicle terminal 300 receives the first signal transmitted from the sever apparatus 500 corresponds to the “first event” according to the present disclosure. The key sensor 601 in the present embodiment corresponds to the “first sensor” according to the present disclosure. The bonnet sensor 602 in the present embodiment corresponds to the “second sensor” according to the present disclosure. The intrusion sensor 603 in the present embodiment corresponds to the “third sensor” according to the present disclosure. The auxiliary storage unit 303 of the in-vehicle terminal 300 in the present embodiment corresponds to the “memory” according to the present disclosure.

### Second Embodiment

In the first embodiment described above, an example in which the “first event” according to the present disclosure is an event in which the in-vehicle terminal 300 receives a first signal transmitted from the server apparatus 500 is described. In contrast, in the present embodiment, an example in which the “first event” according to the present disclosure is an event in which the ignition switch of the vehicle 10 is switched from on to off will be described.

In the remote service, if the state of the vehicle 10 is in a state that is not suitable for parking (first state) when an event in which the ignition switch of the vehicle 10 is switched from on to off occurs, the in-vehicle terminal 300 transmits an inadvertent notification signal to the user terminal 400 through the server apparatus 500 (inadvertent notification process).

The “first state” referred to here is, for example, (4) a state in which the doors of the vehicle are not locked, (5) a state in which the lighting device (headlights and/or small lights) of the vehicle is not turned off, and (6) the windows of the vehicle are not closed, or (7) the hazard lamps of the vehicle are not turned off. The “inadvertent notification signal” is a signal including information indicating that the vehicle 10 is in the first state.

The first user who receives the inadvertent notification signal through the user terminal 400 can return to the vehicle 10 or remotely operate the vehicle 10 to lock the door, to turn off the lighting device, to turn off the hazard lamps, and to close the windows.

By the way, after the ignition switch of the vehicle 10 is switched from on to off, the first user may take a break in the vehicle 10 or in the vicinity of the vehicle outside of the vehicle 10. Furthermore, after the ignition switch of the vehicle 10 is switched from on to off, the first user may perform work such as car washing or inspection in the vehicle 10 or in the vicinity of the vehicle outside of the vehicle 10. In these cases, it is highly possible that the first user intentionally sets the state of the vehicle 10 to the first state. In such a case, if the inadvertent notification signal transmitted to the user terminal 400, the first user may feel annoyed.

Therefore, in the present embodiment, if the BT communication between the user terminal 400 and the BT device 200 is established when the ignition switch of the vehicle 10 is switched from on to off, the in-vehicle terminal 300 performs a process different from the inadvertent notification process. In one example, the in-vehicle terminal 300 performs a process of transmitting a signal indicating the state of the vehicle 10 to the user terminal 400 in real time through the server apparatus 500 (hereinafter, such process may be referred to as “real-time distribution process”). In the present embodiment, the real-time distribution process is continued until the BT communication between the user terminal 400 and the BT device 200 is no longer established.

The process of determining whether BT communication between the user terminal 400 and the BT device 200 is established when the ignition switch of the vehicle 10 is switched from on to off is performed by the determining unit F310 of the in-vehicle terminal 300. The determination process described above is executed in the same procedure as in the first embodiment described above.

The determination result by the determining unit F310 is passed from the determining unit F310 to the controller F320 together with information indicating that the ignition switch has been switched from on to off. The controller F320 executes either the inadvertent notification process or the real-time distribution processing depending on the determination result of the determining unit F310.

(Processing Flow)

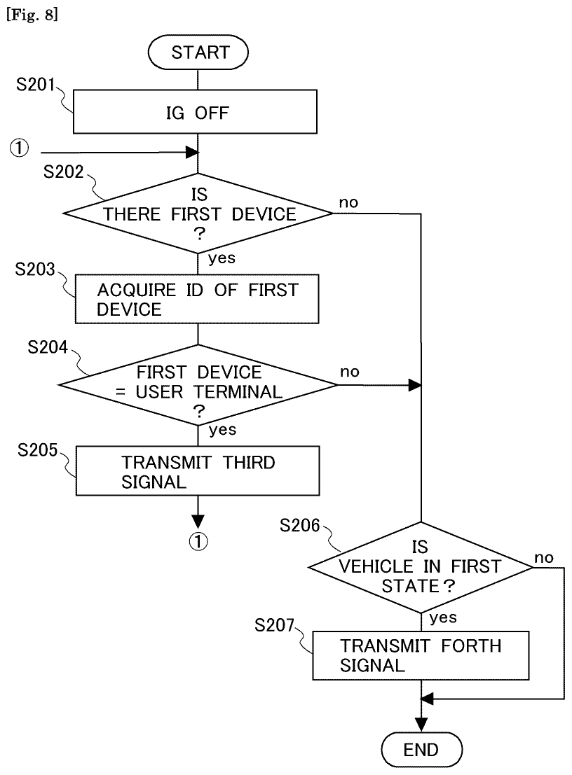

Here, the processing flow performed by the in-vehicle terminal 300 in the present embodiment will be described based on FIG. 8. FIG. 8 is an example of a flowchart of a processing routine executed by the in-vehicle terminal 300, triggered by the ignition switch being switched from on to off. Here, as in FIG. 7 of the First Embodiment described above, in the following description, it will be described as the processing routine of FIG. 8 being executed by the functional components of the in-vehicle terminal 300.

In FIG. 8, when the operation (IG off) of switching the ignition switch of the vehicle 10 from on to off is performed by the first user (step S201), the determining unit F310 of the in-vehicle terminal 300 executes the processes of steps S202 to S204. The processes in steps S202-S204 are the same as those in steps S102-104 in FIG. 7 described above.

When the positive determination is made in step S202 and step S204 (when BT communication between the user terminal 400 and the BT device 200 is established), the controller F320 executes the process of step S205. In step S205, the controller F320 executes a process of transmitting the third signal to the user terminal 400 through the server apparatus 500 (real-time distribution process).

In the real-time distribution process, the controller F320 collects information indicating the current state of the vehicle 10 by communicating with the ECU 100 through the in-vehicle communication unit 304. The information indicating the state of the vehicle 10 at the present time may include, for example, information indicating whether or not the smart key is in the interior of the vehicle 10, information indicating locking/unlocking of the doors, information indicating turning on/off of the lighting device, information indicating turning on/off of the hazard lamps, information indicating whether the windows are open, and the like.

The controller F320 generates a third signal including the collected information, the vehicle ID, and a command to cause the input/output unit 404 of the user terminal 400 to output the collected information. The controller F320 transmits the generated third signal to the server apparatus 500 through the vehicle-outside communication unit 305.

In the server apparatus 500 that has received the third signal, the processor 501 identifies the user terminal 400 associated with the vehicle 10 based on the vehicle ID included in the third signal. The processor 501 of the server apparatus 500 transmits the third signal to the user terminal 400 through the communication unit 504.

In the user terminal 400 that has received the third signal, the processor 301 causes the touch panel of the input/output unit 404 to display information included in the third signal (information indicating the state of the vehicle 10 in real time).

When the controller F320 finishes executing the process of S205, the determining unit F310 executes the process after S202 again.

When the negative determination is made in step S202 and step S204, the controller F320 executes the process in step S206. In step S206, the controller F320 determines whether the vehicle 10 is in the first state. Specifically, the controller F320 determines whether at least one of the conditions (4)-(7) described above is satisfied by communicating with the ECU 100 through the in-vehicle communication unit 304. When at least one of the conditions (4)-(7) described above is satisfied (positive determination in step S206), the controller F320 executes the process in step S207.

In step S207, the controller F320 executes a process of transmitting the fourth signal to the server apparatus 500 (inadvertent notification process). Specifically, the controller F320 generates a fourth signal including information indicating that the vehicle 10 is in the first state, a vehicle ID, and a command for causing the input/output unit 404 of the user terminal 400 to output information indicating that the vehicle 10 is in the first state. The controller F320 transmits the generated fourth signal to the server apparatus 500 through the vehicle-outside communication unit 305.

In the server apparatus 500 that has received the fourth signal, the processor 501 identifies the user terminal 400 associated with the vehicle 10 based on the vehicle ID included in the fourth signal. The processor 501 of the server apparatus 500 transmits the fourth signal to the user terminal 400 through the communication unit 504.

In the user terminal 400 that has received the fourth signal, the processor 301 causes the touch panel of the input/output unit 404 to display information included in the fourth signal (information indicating that the vehicle 10 is in the first state).

When the controller F320 finishes executing the process of step S207, the execution of the present process routine is terminated. Furthermore, in step S206, if none of the above (4)-(7) is satisfied (negative determination in step S206), the execution of the processing routine is terminated without executing the processing in step S207.

According to the above-described embodiment, inadvertent notification to the user terminal 400 is not performed from the ignition switch being switched from on to off until the first user leaves the vehicle 10 (until the first user moves outside the range where BT communication between the user terminal 400 and the BT device 200 is established). This can suppress the user from feeling troublesome. As a result, the convenience of the user can be enhanced.

### <Others>

The above embodiment has been described only by way of example. The technology disclosed herein can be implemented in modified manners without departing from the essence of this disclosure. Processing and features that have been described in the above description of the embodiment may be employed in any combination so long as it is technically feasible to do so. One or some of the processes that have been described as processes performed by one apparatus may be performed by a plurality of apparatuses in a distributed manner. One or some of the processes that have been described as processes performed by two or more apparatuses may be performed by one apparatus. The hardware configuration employed to implement various functions in a computer system may be modified flexibly.

The technology disclosed herein can be implemented by supplying a computer program(s) (i.e. information processing program) that implements the functions described in the above description of the embodiment to a computer to cause one or more processors of the computer to read and execute the program(s). Such a computer program(s) may be supplied to the computer by a computer-readable, non-transitory storage medium that can be connected to a system bus of the computer, or through a network. The computer-readable, non-transitory storage medium refers to a recording medium that can store information, such as data and programs, electrically, magnetically, optically, mechanically, or chemically in such a way as to allow the computer or the like to read the stored information. Examples of such a non-transitory, computer-readable recording medium include any type of discs including magnetic discs, such as a floppy disc (registered trademark) and a hard disk drive (HDD), and optical discs, such as a CD-ROM, a DVD, and a Blu-ray disc. The computer-readable, non-transitory storage medium may include other storage media, such as a ROM, a RAM, an EPROM, an EEPROM, a magnetic card, a flash memory, an optical card, and a solid state drive (SSD).

What is claimed is:

1. An in-vehicle terminal that performs a processing related to a remote service of a vehicle, comprising a controller including at least one processor,
wherein the controller is configured to execute processing of:
executing a first process in a case where short-range wireless communication between the vehicle and a user terminal is not being established at the time when a first event occurs; and
executing a second process different from the first process in a case where short-range wireless communication between the vehicle and the user terminal is being established at the time the first event occurs.

2. The in-vehicle terminal according to claim 1, wherein
the first event is that the in-vehicle terminal receives a signal requesting remote operation of the vehicle,
the first process includes a process of determining whether a first condition is satisfied and a process of accepting the remote operation when it is determined that the first condition is satisfied, and
the second process is a process of accepting the remote operation without determining whether the first condition is satisfied.

3. The in-vehicle terminal according to claim 2, wherein
the process of accepting the remote operation is a process in which the controller transmits a signal requesting an operation corresponding to the remote operation to a first electronic control unit (ECU) mounted on the vehicle.

4. The in-vehicle terminal according to claim 2, wherein
the first condition includes a condition that a first sensor which detects a smart key present in an interior of the vehicle does not detect the smart key.

5. The in-vehicle terminal according to claim 2, wherein
the first condition includes a condition that a second sensor which detects that a bonnet hood of the vehicle is open does not detect that the bonnet hood is open.

6. The in-vehicle terminal according to claim 2, wherein
the first condition includes a condition that a third sensor which detects a moving object intruding into an interior of the vehicle does not detect the moving object.

7. The in-vehicle terminal according to claim 1, wherein
the first event is that an ignition switch is switched from on to off,
the first process includes a process for determining whether the state of the vehicle is in the first state, and a process for transmitting a signal indicating the first state to the user terminal through a server apparatus outside the vehicle when the state of the vehicle is determined to be in the first state, and
the second process includes a process of transmitting a signal indicating the state of the vehicle to the user terminal in real time through the server apparatus.

8. The in-vehicle terminal according to claim 7, wherein
the first state is a state in which doors of the vehicle are not locked.

9. The in-vehicle terminal according to claim 7, wherein
the first condition is a condition in which a lighting device of the vehicle is not turned off.

10. The in-vehicle terminal according to claim 7, wherein
the first condition is a condition in which windows of the vehicle are not closed.

11. The in-vehicle terminal according to claim 7, wherein
the first condition is a condition in which hazard lamps of the vehicle are not turned off.

12. The in-vehicle terminal according to claim 1, further comprising a memory configured to store information identifying the user terminal, wherein the controller configured to execute processing of:
acquiring an identification information of a first device in which short-range wireless communication has been established with the vehicle;
determining whether the first device is the user terminal based on the information stored in the memory and the identification information of the first device;
determining that short-range wireless communication between the vehicle and the user terminal is being established in a case where it is determined that the first device is the user terminal; and
determining that short-range wireless communication between the vehicle and the user terminal is not being established in a case where it is determined that the first device is not the user terminal.

13. An information processing method related to remote service of a vehicle,
wherein a computer mounted on the vehicle executes the processing of:
determining whether short-range wireless communication between the vehicle and a user terminal is being established at the time a first event occurs;
executing a first process in a case where it is determined that short-range wireless communication between the vehicle and the user terminal is not being established; and
executing a second process different from the first process in a case where it is determined that short-range wireless communication between the vehicle and the user terminal is being established.

14. The information processing method according to claim 13, wherein
the first event is that the computer receives a signal requesting remote operation of the vehicle,
the first process includes a process of determining whether a first condition is satisfied and a process of accepting the remote operation when it is determined that the first condition is satisfied, and
the second process includes a process of accepting the remote operation without determining whether the first condition is satisfied.

15. The information processing method according to claim 13, wherein
the first event is that an ignition switch is switched from on to off,
the first process includes a process for determining whether the state of the vehicle is in the first state, and a process for transmitting a signal indicating the first state to the user terminal through a server apparatus outside the vehicle when the state of the vehicle is determined to be in the first state, and
the second process includes a process of transmitting a signal indicating the state of the vehicle to the user terminal in real time through the server apparatus.

16. The information processing method according to claim 13, wherein the computer further comprises a memory configured to store information identifying the user terminal, and the computer is configured to execute processing of:
acquiring an identification information of a first device in which short-range wireless communication has been established with the vehicle;
determining whether the first device is the user terminal based on the information stored in the memory and the identification information of the first device;
determining that short-range wireless communication between the vehicle and the user terminal is being established in a case where it is determined that the first device is the user terminal; and
determining that short-range wireless communication between the vehicle and the user terminal is not being established in a case where it is determined that the first device is not the user terminal.

17. A vehicle equipped with a first communication apparatus configured to perform short-range wireless communication with a user terminal and an in-vehicle terminal configured to perform processing related to a remote service of a vehicle, wherein the in-vehicle terminal comprising a controller including at least one processor is configured to execute processing of:
determining whether short-range wireless communication between the vehicle and the user terminal is being established at the time a first event occurs;
executing a first process in a case where it is determined that short-range wireless communication between the vehicle and the user terminal is not being established; and
executing a second process different from the first process in a case where it is determined that short-range wireless communication between the vehicle and the user terminal is being established.

18. The vehicle according to claim 17, wherein
the first event is that the in-vehicle terminal receives a signal requesting remote operation of the vehicle,
the first process includes a process of determining whether a first condition is satisfied and a process of accepting the remote operation when it is determined that the first condition is satisfied, and
the second process includes a process of accepting the remote operation without determining whether the first condition is satisfied.

19. The vehicle according to claim 17, wherein
the first event is that an ignition switch is switched from on to off,
the first process includes a process for determining whether the state of the vehicle is in the first state, and a process for transmitting a signal indicating the first state to the user terminal through a server apparatus outside the vehicle when the state of the vehicle is determined to be in the first state, and
the second process includes a process of transmitting a signal indicating the state of the vehicle to the user terminal in real time through the server apparatus.

20. The vehicle according to claim 17, wherein the in-vehicle terminal further comprises a memory configured to store information identifying the user terminal, and the controller is configured to execute processing of:
acquiring an identification information of a first device in which short-range wireless communication has been established with the vehicle;
determining whether the first device is the user terminal based on the information stored in the memory and the identification information of the first device;
determining that short-range wireless communication between the vehicle and the user terminal is being established in a case where it is determined that the first device is the user terminal; and
determining that short-range wireless communication between the vehicle and the user terminal is not being established in a case where it is determined that the first device is not the user terminal.
